(19) United States
(12) Patent Application Publication
(10) Pub. No.: US 2022/0058416 A1
(43) Pub. Date: Feb. 24, 2022

(54) PRINTED CHARACTER RECOGNITION

(71) Applicant: Continental Automotive GmbH, Hannover (DE)

(72) Inventors: Veena Vengalil, Singapore (SG); Ravi Mugad, Singapore (SG); Jitendra Kumar, Singapore (SG); Kamal Deep Sethi, Singapore (SG)

(21) Appl. No.: 17/414,482

(22) PCT Filed: Dec. 18, 2019
(86) PCT No.: PCT/EP2019/086100

§ 371 Date: Jun. 16, 2021

(30) Foreign Application Priority Data
Dec. 18, 2018 (GB) 1820569.0

(51) Int. Cl. G06K 9/32; G06K 9/00; G06K 9/03

(52) U.S. Cl. CPC G06K 9/325; G06K 2209/01; G06K 9/036; G06K 9/00818

(57) ABSTRACT

A computer-implemented method for recognising a printed character string is provided. The method includes receiving an image comprising the character string, the character string comprising a plurality of characters, determining a readability quality for each character in the character string and selecting at least one anchor character based at least in part on the readability quality of the characters in the character string. The identity of the at least one anchor character is determined using a character recognition algorithm and the identity of the character string recognised based on the at least one identified anchor character.

### CROSS REFERENCE TO RELATED APPLICATIONS

This application is the U.S. National Phase application of PCT International Application No. PCT/EP2019/086100, filed Dec. 18, 2019, which claims priority to Great Britain Patent Application No. 1820569.0, filed Dec. 18, 2018, the contents of such applications being incorporated by reference herein.

### FIELD OF THE INVENTION

The present disclosure relates to computer-implemented methods and devices for recognising printed characters such as but not limited to printed characters located on traffic signs.

### BACKGROUND OF THE INVENTION

Various computer implemented methods and devices have been developed for recognising the identity of printed character strings. Often these methods include processing an image of the printed character string which has been taken by an image sensor. The image sensor may be a camera located on a vehicle or a mobile device such as handphones or tablets. Information contained in the identified character strings may then be used to facilitate the performance of various functions.

For example, a user may take a picture of a name card using his mobile phone and trigger a character string recognition software to recognise the identity of character strings in the software. A navigation application on the mobile phone may then use the identified character strings to filter out which characters provide address information and provide navigation directions to the address on the name card. Software and devices for recognising printed character strings may also be used to interpret traffic signs. For example, an image containing a traffic sign may be captured by a front facing camera located in a vehicle and processed by an algorithm configured to recognise printed character strings. Depending on the content of the character strings, one or more actions may be triggered accordingly. For example, if the traffic sign contains the word SCHOOL or ANIMAL CROSSING, a warning may be issued to a driver of the vehicle so that the driver may slow down the vehicle or be on the alert for vulnerable road users. If the vehicle is driven in an autonomous or semi-autonomous mode, an autonomous driving module of the vehicle may also be triggered to slow down the vehicle speed accordingly. However, most character string recognition methods are programmed to identify all the characters in a character string and recognise the character string based on all the identified characters. This can be a problem when one or more characters in a character string are poorly resolved, either because the original character is by itself unclear or the image acquisition process itself. Other factors such as the environment in which the image was captured may also play a part. A poorly resolved character is more likely to be wrongly identified which in turn affects the ability to correctly recognise the identity of a character string. Recognition methods which rely on characters in fixed positions to recognise the identity of character strings also suffer from the same problem.

In view of the above, there is a demand for improved methods and devices for recognising printed character strings.

### SUMMARY OF THE INVENTION

Aspects of this disclosure provide computer-implemented methods and devices for recognising printed character strings such as but not limited to printed characters found on traffic signs.

One aspect of this disclosure provides a method for recognising a printed character string comprising receiving an image comprising the character string, the character string comprising a plurality of characters. The method further comprises determining a readability quality for each character in the character string. At least one anchor character is then selected based at least in part on the readability quality of the characters in the character string. That is, the selection of anchor characters is based at least in part on which characters have the best readability quality. More than one anchor character may also be chosen with the number of anchor characters chosen dependent on factors such as the length of the character string. The identity of the at least one anchor character is then determined using a character recognition algorithm such as an optical character recognition software. The identity of the character string is then recognised based on the at least one identified anchor character. There are certain advantages associated with recognising the identity of a character string using anchor character(s) selected on the basis of readability quality. As discussed in the background section, processes which recognise the identity of a character string based on the identity of all the characters in a character string suffer from recognition errors when one or more characters in the character string are poorly resolved. Processes which recognise the identity of a character string based on the identity of characters in fixed positions similarly lack flexibility and can result in character strings being wrongly recognised when the characters in the fixed positions are poorly resolved. By selecting anchor characters based at least in part on the respective readability quality of the characters, this disclosure provides a method which is adaptive to variations in the readability of characters appearing in a character string. In some implementations, the number of anchor characters selected is less than the total number of characters in the character string. Since the methods in this disclosure only require the identity of the anchor character(s) to be determined using a character recognition algorithm, processing time and demands on computing resources are reduced when the number of anchor characters is fewer than the total number of characters in a character string particularly for long character strings. The identity of a character string is then recognised based on the identity of the anchor character(s). The number of anchor characters selected may be based, for example, on a rule which states that only characters with a readability quality above a specified threshold may be selected as anchor characters. Additionally, or alternatively the number of anchor characters being selected may be based on a rule which pre-defines the number of anchor characters based at least in part on a length of the character string, that is, the number of characters in the character string. For example, the rule may specify that three anchor characters are selected for character strings consisting of six characters and those three with the best readability quality are chosen.

In an optional variation, the method further comprises segmenting the characters in the character string into individual characters before determining the readability quality of each character. It may also be appropriate to define what constitutes a valid character and filter out characters which are invalid before determining the readability quality. The filtered out invalid characters are not considered as part of the character string and the readability quality assessment is conducted on characters remaining after the invalid ones have been filtered out. By way of example, it may be appropriate in certain context to only consider text characters such as alphabets, words and numbers as valid characters and other types of characters such as punctuation and icons as invalid characters. Whitespace may also be considered as an invalid character. The filtering out of invalid characters may be performed after the segmenting the characters in the character string before the readability quality of the characters is determined.

The readability quality for each character may be determined based on one or more readability criteria. In some variations, readability quality may be calculated by taking an average or weighted average of a character's score for each criterion. Other formulas which calculate readability quality based on one or more readability criteria may also be suitable. In an exemplary implementation, the readability quality for each character is determined based on at least one of the following readability criteria: image quality, dimensions and aspect ratio of each character. Aspect ratio refers to the ratio of the width to height of a character. Image quality may be assessed based one or more factors such as clarity, noise level, level of distortion, resolution and whether a character appears as distinctly separated from an adjacent character or merged. There may be one or more readability criteria which is tied to character dimensions. For example, characters below a specified size may be assigned a low readability quality score because they are too small to be accurately identified. For the remaining characters which are larger than the specified size, their readability quality may be assessed based on a rule whereby characters of a larger size are considered to be more readable. By way of example, the numbers “1900” in a character string containing “1900m” may be considered to be more readable compared to small letter m when lighting conditions fall below a threshold because the numbers are of a larger size. However, the final readability quality of each character may ultimately depend on a combination of various readability criteria. In another variation, character size may only be an applicable readability criterion under certain circumstances. For example, when lighting conditions in an image containing the character string falls below a threshold level. In such instances, either characters with smaller dimension may be considered as less readable when determining readability quality or characters with smaller dimensions are rated with lower priority when selecting the at least one anchor character.

In another exemplary implementation, the steps of determining the readability quality for each character or selecting at least one anchor character may be based at least in part on the shooting direction of the image sensor with respect to a plane on which the character string is located. By way of example, the image may be captured by an image sensor mounted on a vehicle and the character string is located on a traffic sign. In such situations, the shooting direction of the image sensor with respect to the traffic sign may be determined based on the direction of motion of the vehicle when the image was captured. In some variations, if the vehicle is turning with respect to the plane of the traffic sign, the readability quality is considered to decrease the closer the characters are to an edge of the traffic sign. According to another aspect of this disclosure, implementations of this disclosure may also be in the form of a non-transitory computer-readable storage medium comprising computer-readable instructions for carrying out the aforementioned methods.

Another aspect of the disclosure provides a device for recognising a printed character string comprising a processor and

at least one memory coupled to the processor and storing instructions executable by the processor causing the processor to:

receive an image comprising the character string, the character string comprising a plurality of characters and determine a readability quality for each character in the character string. The processor is further caused to select at least one anchor character based at least in part on the readability quality of the characters in the character string, determine the identity of the at least one anchor character using a character recognition algorithm and recognise the identity of the character string based on the at least one identified anchor character.

In some implementations, the at least one memory may also further cause to processor to filter out invalid characters from the character string before determining a readability quality for each character remaining after the filtering. In an optional implementation, the readability quality for each character may be determined based on at least one of the following readability criteria: image quality, dimensions and aspect ratio of each character. In another variation, the at least one memory may also further cause the processor to determine if lighting conditions in the image fall below a threshold level, and if the lighting conditions fall below the threshold level, either characters with smaller dimension are considered as less readable when determining readability quality or characters with smaller dimensions are rated with lower priority when selecting the at least one anchor character. In implementations where the image sensor is mounted on a vehicle, the least one memory causes the processor to determine the readability quality for each character or select at least one anchor character based at least in part on the shooting direction of the image sensor with respect to a traffic sign on which the character string is located. The shooting direction of the image sensor may be determined based on the direction of motion of the vehicle when the image was captured.

According to a further aspect of this disclosure, a vehicle comprising a device for recognising a printed character string as described in the succeeding sentences may be provided.

The details of one or more implementations of the disclosure are set forth in the accompanying drawings and the description below. Other aspects, features, and advantages will be apparent from the description and drawings, and from the claims.

### BRIEF DESCRIPTION OF THE FIGURES

FIG. 1 is a functional block diagram of a system 100 comprising a character string recognition device according to one implementation of this disclosure.

FIG. 2 is a flow diagram illustrating a computer-implemented method for recognising a printed character string according to some implementations of this disclosure.

FIG. 3 illustrates an exemplary method for recognising the character string SCHOOL according to one variation of the method described in FIG. 2.

### DETAILED DESCRIPTION OF THE EXEMPLARY EMBODIMENTS

In the following detailed description, reference is made to the accompanying figures. In the figures, similar symbols typically identify similar components, unless context dictates otherwise.

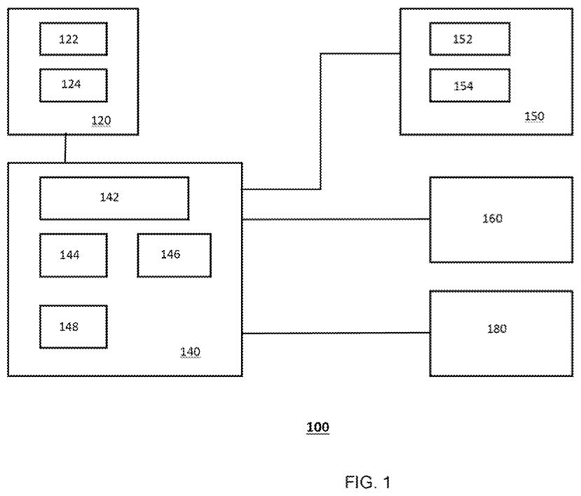

FIG. 1 is a functional block diagram of an exemplary system 100 associated with a vehicle comprising an image sensor module 120, a machine vision module 140, a vehicle system 150, an autonomous driving module 160 and a human machine interface (HMI) module 180 according to one implementation of this disclosure. The image sensor module 120 comprises two or more image sensors (122, 124) operative to capture images of an external environment of the vehicle. The image sensors may be mounted at different parts of the vehicle in order to capture images of different parts of the vehicle's environment. For instance, the first image sensor 122 may be a front mounted camera which is used to capture images in a forward-facing direction of the vehicle while the second image sensor 124 may be a rear-facing camera. The first image sensor 122 may be located on an interior rear-view mirror of the vehicle. The image sensors (122, 124) may also be configured to continuously capture images of the external environment so long as the vehicle ignition is switched on or capture images on a demand basis. It will be appreciated by a person skilled in the art that other types and numbers of image sensors may also be used in the image sensor module 120.

The machine vision module 140 is in communication with the image sensor module 120 and comprises one or more sub-modules which are configured to process and/or analyse images taken by the image sensors in the image sensor module. In the FIG. 1, the machine vision module 140 is configured to facilitate the operation of one or more driver assistance functions based on the content of the images. For example, the machine vision module 140 comprises an image processing device (142), a traffic sign recognition (TSR) device (144), a character string recognition device (146) and a lane departure warning device (148). In some implementations, the image processing device 142 may be configured to pre-process incoming images before sending them to the other sub-modules for further processing. The pre-processing of images may include operations such as noise removal and colour adjustment. As for the TSR device 144, it may be operable to detect for the presence of traffic signs in incoming images captured by the front facing first image sensor 122. Characteristics associated with an object such as shape and location may be used as criteria for determining if an object appearing in an image is a traffic sign. Upon detecting an object of interest which may potentially be a traffic sign, the TSR device 144 sends an image of the detected traffic sign to the character string recognition device 146. The character string recognition device 146 then interprets the contents of one or more printed character strings in the traffic sign using one or more methods described in this disclosure. For instance, in this disclosure, at least one anchor character in a character string is chosen and the identity of the anchor character(s) determined using a character recognition algorithm. The character string is then interpreted based on the one or more identified anchor characters. Therefore, the present disclosure uses anchor characters instead of all the characters in a character string to interpret a character string. The anchor characters are also chosen in an adaptive manner, based on a comparison of the readability quality of the characters in a character string instead of predefining the location in a character string from which anchor characters are to be chosen. Various criteria related to the ease of identifying a text associated with a character such as image quality, dimension, aspect ratio or a combination thereof may be used to assess readability quality. In some implementations, the shooting direction of an image sensor with respect to the plane on which the character string is located is considered when assessing readability quality. For instance, when images are captured by an image sensor located on a vehicle, the vehicle's direction of motion when the image was taken may be used to determine the shooting direction of the image sensor. Referring to the FIG. 1 example, the character string recognition device 146 may determine the vehicle's turning angle and hence direction of motion based on the steering wheel position, wheel angle position or a combination thereof. These readings may be obtained from a steering angle sensor (152) and/or a wheel angle sensor (154) located within the vehicle system 150. In the FIG. 1 implementation, the machine vision module 140 also comprises a lane departure module 148 which may be configured to determine which lane the vehicle is in and if the vehicle is keeping within its lane by analysing images of lane markings appearing in images captured by one or more image sensors (122,124).

In some implementations, the machine vision module 140 comprises a computing processor and a hardware memory in communication with the processor. The computing processor may, for example, be a microcontroller or graphics processing units (GPU) capable of accessing the memory to store information and execute instructions stored therein. In one variation, the image processing device 142, TSR device 144, character string recognition device 146 and lane departure device 148 are stored as software algorithms in a memory associated with the machine vision module 140. The software algorithms are retrieved from the memory by a computing processor and executed by the computing processor. In other variations, the machine vision module 140 may also comprise more than one computing processor and/or memory. The respective sub-modules in the machine vision module 140 may have its own dedicated computing processor and memory or share it with another sub-module. For instance, the character string recognition device 146 may have its own dedicated processor and memory or share these resources with at least the TSR device 144. In another implementation, the machine vision module 140 may be implemented as one or more system on chips (SOCs), each configured to perform one or more the functions of the various sub-modules in the machine vision module described herein. Additionally, it will be appreciated by an ordinary person skilled in the art that the functions of each sub-module in the machine vision module 140 such as the character string recognition device 146 may be implemented by multiple processors and/or memories located in different housing. Accordingly, references to a processor or memory will be understood to include references to a collection of processors and/or memories that operate to perform the functions of a device for recognising a printed character string described in this disclosure.

In the FIG. 1 example, the machine vision module 140 is also in communication with the autonomous driving module 160 and the HMI module 180. By way of example, the machine vision module 140 may be communicatively coupled to the other modules via a controller area network (CAN) bus. The autonomous driving module 160 is responsible for controlling the vehicle's semi-autonomous and autonomous driving functions such as adaptive cruise control (ACC), active lane assist, highly automated driving (HAD) and park assist. It typically comprises a supervisory electronic control unit (ECU) which plans, co-ordinates and executes the various semi-autonomous and autonomous driving functions by receiving data/instructions from various vehicle modules, analysing them and sending instructions to for example, a powertrain, steering and braking module in order to effect the desired vehicle manoeuvre. As for the HMI module 180 associated with the vehicle, it may be used for communicating audio and visual messages to a driver of the vehicle. For instance, the HMI module 180 may comprise components such as an instrument panel, an electronic display and an audio system. The instrument panel may be a dashboard or a centre display which displays for example, a speedometer, tachometer and warning light indicators. The user interface may also comprise an electronic display such as an infotainment or heads-up display for communicating other visual messages to the driver and an audio system for playing audio messages, warning or music. In some implementations, the TSR device 144 or character string recognition device 146 may be configured to cause one or more actions to be executed based on the contents of one or more printed character strings in a traffic sign. For instance, the TSR device 144 may determine that the vehicle is approaching a school zone if the character string recognition device identifies the word “SCHOOL” on a traffic sign appearing in an image captured by the front facing image sensor 122. The TSR may also cause actions to be executed based on the content of multiple character strings on a traffic sign. The TSR device 144 may then transmit this information to the autonomous driving module 160 or HMI module 180 along with other relevant information such as distance of the vehicle from the sign so that appropriate action may be taken. For example, the autonomous driving module 160 may be configured to regulate a speed of the vehicle in response to being notified that the vehicle is approaching a school zone. A driver of the vehicle may also be warned of the fact via visual and/or aural signals emitted by the HMI module 180 so that he may watch out for any playing children. Although FIG. 1 shows the character string recognition device being used for interpreting character strings on traffic signs, this is not intended to be limiting on this disclosure. For example, the character string recognition device may also be used to decipher text in images taken off a document, a name card or a signboard. The character string recognition device may also be located on other platforms including mobile electronic devices such as handphones and tablets.

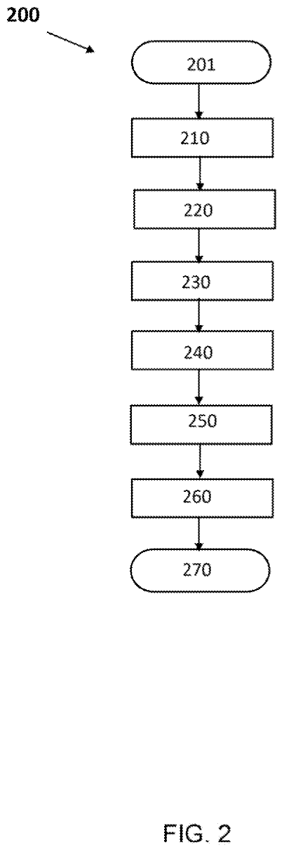

FIG. 2 is a flowchart illustrating an exemplary process 200 for recognising a printed character string according to one implementation of this disclosure. The operations of process 200 will be described with reference to the system in FIG. 1. However, it will be appreciated that this is merely for purposes of illustration and the process may be deployed on character string recognition devices located on other platforms such as mobile user devices. The process starts at step 201 and may be initiated when a request to have printed text recognised is made by a module such as the TSR device 144 in FIG. 1. In some implementations, images containing printed text may be pre-processed before the text recognition device commences the recognition process. For instance, in order to improve character recognition accuracy, the quality of a text containing image may be enhanced by using one or more image enhancement processes. Examples include image enhancement processes that reduce noise and/or sharpen images such as histogram equalization, noise reduction by filtering, image sharpening using Laplacian filters or a combination thereof. The image enhancement pre-processing may be carried out by the character string recognition device itself, another module or a combination thereof. In some variations, the image enhancement pre-processing may be implemented by an image processing device 142 located within a machine vision module 140 like in FIG. 1. In some implementations, the character string recognition device 146 may be configured to separate an incoming image containing multiple character strings into individual character strings before the character string recognition process commences in block 210. After the separation process, the individual character strings in a sequence of incoming printed characters may be recognised by processing each character string sequentially using blocks 210 to 260. Alternatively, multiple character strings may also be processed concurrently by executing blocks 210 to 260 in parallel.

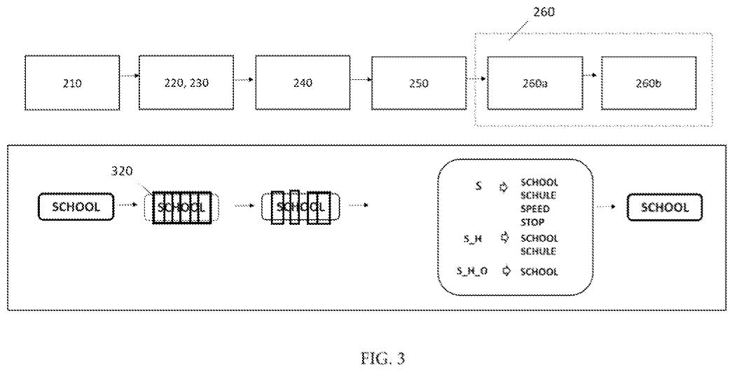

In block 210, the starting of the process in block 201 causes the character string recognition device 146 to receive an image comprising a character string. The character string may comprise a plurality of characters. For purposes of illustration, we will assume that the character string in the image received in block 210 is the word SCHOOL (see FIG. 3). The functions of the character string recognition device in this disclosure may be implemented by a computing processor and a memory in communication with the processor. The processor being operable to accessing the memory to store information and execute instructions stored therein. In other implementations, multiple processors and/or memories located in different housing may also be used to implement the functions of the character string recognition device. Accordingly, references to a processor or memory will be understood to include references to a collection of processors and/or memories that operate to perform the functions of a device for recognising a printed character string described in this disclosure.

In one optional variation of this disclosure, the incoming image is subjected to a segmentation process by a processor for the character string recognition device in block 220 prior to determining the readability quality for each character in block 230. The segmentation process separates the characters in a character string into individual characters or character segments. In one variation illustrated in FIG. 3, each character segment comprises a character enclosed within a bounding box 320. The respective character segments may be formed by segmenting the characters in a character string and constructing a bounding box around each segmented character. This may be achieved by adaptive thresholding followed by connected component analysis. For example, adaptive thresholding may be used to binarize a grey level image and connected component analysis extracts symbols in a bounding box based on the connected pixels of a symbol. Adaptive thresholding and connected component analysis are known but this disclosure further discloses the concept of having a novel adaptive connected component analysis which switches between different number of connected components depending on whether the image is taken during the day or night. For example, 4 connected components may be used for images taken at night and 8 connected components for those taken during the night. The rationale is that noise is higher during night time and using a lower number of connected components helps to avoid over segmentation. In some implementations, the dimensions of the bounding boxes are dependent on the dimensions of the characters being enclosed.

Other segmentation processes which are suitable for separating characters in a character string may also be suitable. In some implementations, it may be appropriate to define what constitutes a valid character and characters which are invalid may be filtered out and not considered as part of the character string. By way of example, it may be appropriate in certain context to only consider text characters such as alphabets, words and numbers as valid characters and other types of characters such as punctuation and icons as invalid characters. A character segment enclosing whitespace may also be considered as an invalid character segment. Invalid characters from a character string may be filtered out before determining a readability quality for each remaining character in block 230. In some implementations where the dimensions of the bounding boxes are sized according to the dimensions of the content being enclosed, information on the respective bounding boxes may be used to filter out invalid character segments. Bounding box information that may be used for filtering out invalid character segments include dimensions and/or aspect ratio of a bounding box. For instance, the fact that the height and/or width of a bounding box does not fall within specified limits (e.g. the dimensions are too small) may be indicative that the bounding box does not contain a valid character. The limits on bounding box dimensions may be pre-defined or established based on a comparison with other bounding boxes in the same character string or multiple character strings originating from the same source (e.g. traffic sign). The co-ordinate position of a bounding box may also be used additional or alternatively as a filtering criterion, the expected co-ordinate positions being based on the spacing between other bounding boxes from the same character string/source.

The process then goes on to block 230 where the processor determines a readability quality for each character in the character string. For implementations where invalid character segments are filtered out in block 220, the readability quality assessment is conducted on character segments remaining after the invalid ones have been filtered out. One or more readability criteria may be considered when determining the readability quality of a character. In some variations, readability quality may be calculated by taking an average or weighted average of a character's score for each criterion. Other formula which calculate readability quality based on one or more readability criteria may also be suitable. In some implementations, readability quality may be computed based at least in part on one of the following: image quality, dimensions and/or aspect ratio of a character. Image quality may be assessed based one or more factors such as clarity, noise level, level of distortion, resolution and whether a character appears as distinctly separated from an adjacent character or merged. It is more difficult to accurately identify the text associated with a character if the character is merged with one or more adjacent characters. The dimensions of each character, that is, width, height or a combination thereof may also be considered. In implementations where each character is enclosed by a bounding box of dimensions sized according to that of the character enclosed, character dimensions may be estimated based on the dimensions of the bounding box. There may be one or more readability criteria which is tied to character dimensions. For example, characters below a specified size may be assigned a low readability quality score because they are too small to be accurately identified. For the remaining characters which are larger than the specified size, their readability quality may be assessed based on a rule whereby characters of a larger size are considered to be more readable. The foregoing rule on readability versus size may also be applied in isolation. In another variation, the recognition process may only consider character size to be a relevant readability criterion under certain circumstances. For example, when lighting conditions in an image containing the character string falls below a specified threshold level. In general, the identity of a character becomes more difficult to recognise when lighting conditions fall below a certain level. Under such circumstances a larger character may be more easily identifiable compared to a smaller character with similar image quality. By way of example, the numbers “1900” in a character string containing “1900m” may be considered to be more readable compared to small letter m when lighting conditions fall below a threshold because the numbers are of a larger size. However, the final readability quality of each character may ultimately depend on a combination of various criteria such as image quality and aspect ratio. As discussed above, aspect ratio which refers to the ratio of the width to height of a character may also be used as a readability criterion. Aspect ratio is relevant because characters which are tall and narrow or wide and short may be more difficult to decipher. The inventors have found the range of preferred aspect ratio to be dependent on the type of image sensor used. Therefore, the preferred aspect ratio range may be defined by varying the aspect ratio of characters and checking for their ease and/or accuracy of recognition by character recognition algorithm. For instance, in some implementations, characters with an aspect ratio within a specified range such as 0.6 to 0.9 may be considered as more readable. Apart from the characteristics of the individual characters themselves, other factors may also influence readability quality. For example, the location of a character may become an important readability criterion depending on the shooting direction of the image sensor with respect to a plane on which the character string is located. In general, images of characters tend to be clearer if the shooting direction is directed straight at the plane on which the character string is located, that is, at a 90 degrees angle. The shooting angle becomes particularly relevant when recognising traffic sign images captured by a camera mounted on a moving vehicle. Specifically, if a vehicle is turning at the time when the image was taken, characters lying close to the edge of a traffic sign may likely suffer from directional blur. Accordingly, in some implementations, there may be a rule whereby characters closer to an edge of a traffic sign are considered to be less readable if a vehicle was turning with respect to the plane of a traffic sign. The turning angle and hence direction of motion a vehicle may be derived based on the yaw rate of the vehicle, steering wheel position, wheel angle position or a combination thereof. Referring to the example in FIG. 1, the processor of a character string recognition device 146 may obtain these readings from a steering angle sensor (152) and/or a wheel angle sensor (154) located within the vehicle system 150.

After determining a readability quality for each character in the character string, the process goes on to block 240 where at least one anchor character is selected based on the readability quality of the characters in the character string. In a preferred implementation, the number of anchor characters selected is less than the total number of characters in a character string. Since the methods in this disclosure only require the identity of the one or more anchor characters to be determined using a character recognition algorithm, processing time and demands on computing resources are reduced when the number of anchor characters is fewer than the total number of characters in a character string. The number of anchor characters to be selected may, for example, be based on a rule which states that only characters with a readability quality above a specified threshold may be selected as anchor characters. The processor may additionally or alternatively also be configured to select a pre-defined number of anchor characters based at least in part on the number of characters in a character string being processed. In general, the number of anchor characters preferably increases with the number of characters. As described in the succeeding paragraphs, this disclosure proposes using only the anchor characters to recognise a character string as opposed to using all the characters as is the case in many known character string recognition methods. An issue with using all the characters is that an entire character string may be wrongly recognised if one or more characters are poorly resolved and cannot be accurately identified. The present disclosure addresses this problem by using anchor characters which are selected on the basis of readability quality. Selecting anchor characters based on the actual readability quality of characters is also advantageous over recognition methods which select anchor characters from pre-defined locations. The latter example also suffers from the above discussed issue if one or more characters in the pre-defined locations are poorly resolved. For example, fixing the second character in a character string as an anchor character may result in the character string being wrongly recognised if the second character is wrongly identified due to poor readability quality. This disclosure improves the accuracy of character string recognition by adaptively choosing the anchor characters on based on readability quality. This leads to a corresponding improvement in the accuracy of character string recognition since characters with superior readability quality are more likely to be correctly identified. Referring to the example in FIG. 3, the characters S, H and O are selected as anchor characters as based at least in part on the readability quality of the characters forming the character string SCHOOL. In some implementations, additional anchor character selection criteria may be introduced in order to select an anchor character from two or more characters which have similar readability quality. For instance, characters which are have larger dimensions may be given priority over characters with smaller dimensions when a choice between two or more characters with similar readability quality needs to be made. The anchor character selection criterion for character size may be applied in all situations or only when the lighting conditions in an image fall below a threshold level. In another example, if the shooting direction of an image sensor with respect to a plane on which the character string is located is below certain threshold angles, characters located further away from an edge of a traffic sign may be given higher priority in the anchor character selection.

The method then proceeds to block 250 where the identity of the at least one anchor character selected in block 240 is determined using a character recognition algorithm. Suitable character recognition algorithms which may be used include optical character recognition software. For example, in the FIG. 3 use case, a character recognition software identifies the three anchor characters as the alphabets “S”, “H” and “O”. After the identity of the one or more anchor characters have been identified in block 250, the identity of the character string is recognised in block 260 based on the identified anchor characters. As discussed earlier, the number of anchor characters is preferably less than the number of characters in the character string. In some implementations, the process of recognising the character string in block 260 may be carried out by the TSR device 144 instead of the character string recognition device 146. In such cases, the character string recognition device would form part of the TSR device. In some implementations, the identity of a character string may be recognised by looking up a database or dictionary using information on the total number of characters in the character string, and the identity and location of the anchor characters. For example, in the FIG. 3 use case where the character string originates from a traffic sign, block 260 involves a sign prediction process 260a whereby the initial check comprises looking up a traffic sign database for potential character strings based on the fact that the first anchor character “S” is the first letter in the string. In some variations, the processor may determine the database to be searched based on the source where the character string is taken from and/or geographical location of the source. For instance, in this example, since the source of the character string is a traffic sign, a traffic sign database would be of relevance. Furthermore, if the traffic sign is located in the UK (which can be determined based on the geographical location of the vehicle when the image was taken) then a traffic sign database for UK is looked up. The database may be located in the TSR device 144, the character string recognition device 146 or a remote database which can be accessed by a processor performing the steps in block 260. In the FIG. 3 use case, four possible character strings SCHOOL, SCHULE, SPEED and STOP have been suggested based on the initial search. In another variation (not shown), the number of characters in the character string may also be used as one of the search criteria in the initial search or any of the subsequent searches. In this case, the character string has six characters, therefore, only the character strings SCHOOL and SCHULE. In the FIG. 3 use case, the number of potential candidates is narrowed down to SCHOOL and SCHULE in the second step of the sign prediction process 260a by using the information that the second anchor character “H” is located in the third position. SPEED and STOP have been eliminated via the second step because they do not contain the alphabet “H” in the third position. Finally, the character string is recognised as the word “SCHOOL” based on the information that the third anchor character, “O” is located fifth position. The character string “SCHULE” has been eliminated as an option because the alphabet “L” and not “O” is located in the fifth position. The character string is recognised as the word SCHOOL and this is presented as an output in step 260b of block 260. In the FIG. 2, the process ends in 270 for the current character string thereafter. In some implementations (not shown), one or more additional anchor characters may be chosen based on readability quality if the initial anchor characters chosen results in more than one potential character string is flagged by a prediction process in the character string recognition block 260. Additional attempts are then made to recognise the identity of the character string being processed based on the identity of the additional anchor character(s) and their position. In examples, where the printed character string is taken off a traffic sign, the TSR device 144 may determine the contents of a traffic sign and effect one or more actions based on the identity of multiple character strings recognised by the character string recognition device 146.

While various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular implementations only, and is not intended to be limiting.

1. A computer-implemented method for recognising a printed character string comprising:
receiving an image comprising the character string, the character string comprising a plurality of characters;
determining a readability quality for each character in the character string;
selecting at least one anchor character based at least in part on the readability quality of the characters in the character string;
determining an identity of the at least one anchor character using a character recognition algorithm; and
recognising the identity of the character string based on the at least one identified anchor character.

2. The method of claim 1 wherein a number of anchor characters selected is less than a total number of characters in the character string.

3. The method according to claim 1, wherein a number of anchor characters selected is based at least in part on a length of the character string.

4. The method according to claim 1, further comprising filtering out invalid characters from the character string before determining a readability quality for each character remaining after the filtering.

5. The method according to claim 1, wherein the readability quality for each character is determined based on at least one of the following readability criteria: image quality, dimensions and aspect ratio of each character.

6. The method according to claim 1, further comprising determining if lighting conditions in the image fall below a threshold level.

7. The method of claim 6, wherein if the lighting conditions fall below the threshold level, either characters with smaller dimension are considered as less readable when determining readability quality or characters with smaller dimensions are rated with lower priority when selecting the at least one anchor character.

8. The method according to claim 1, wherein determining the readability quality for each character or selecting at least one anchor character is based at least in part on a shooting direction of the image sensor with respect to a plane on which the character string is located.

9. The method of claim 8, wherein the image is captured by an image sensor mounted on a vehicle and the character string is located on a traffic sign.

10. The method according to claim 9, wherein the shooting direction of the image sensor with respect to the traffic sign is determined based on the direction of motion of the vehicle when the image was captured.

11. The method of claim 10, wherein if the vehicle is turning with respect to the plane of the traffic sign, the readability quality is considered to decrease the closer the characters are to an edge of the traffic sign.

12. A device for recognising a printed character string comprising:
a processor;
at least one memory coupled to the processor and storing instructions executable by the processor causing the processor to:
receive an image comprising the character string, the character string comprising a plurality of characters;
determine a readability quality for each character in the character string;
select at least one anchor character based at least in part on the readability quality of the characters in the character string;
determine an identity of the at least one anchor character using a character recognition algorithm; and
recognise the identity of the character string based on the identity of the at least one anchor character.

13. The device according to claim 12, wherein the at least one memory further causes the processor to:
filter out invalid characters from the character string before determining a readability quality for each character remaining after the filtering.

14. The device according to claim 12, wherein the readability quality for each character is determined based on at least one of the following readability criteria: image quality, dimensions and aspect ratio of each character.

15. The device according to claim 12, wherein the at least one memory further causes the processor to:
determine if lighting conditions in the image fall below a threshold level; and
if the lighting conditions fall below the threshold level, either characters with smaller dimension are considered as less readable when determining readability quality or characters with smaller dimensions are rated with lower priority when selecting the at least one anchor character.

16. The device according to claim 12, wherein:
the image sensor is mounted on a vehicle;
the least one memory causes the processor to determine the readability quality for each character or select at least one anchor character based at least in part on a shooting direction of the image sensor with respect to a traffic sign on which the character string is located, the shooting direction of the image sensor being determined based on the direction of motion of the vehicle when the image was captured.

17. The method according to claim 1, wherein the number of anchor characters selected is based at least in part on a length of the character string.

18. The device according to claim 13, wherein the readability quality for each character is determined based on at least one of the following readability criteria: image quality, dimensions and aspect ratio of each character.
